(19) United States
(12) Patent Application Publication
(10) Pub. No.: US 2019/0352456 A1
(43) Pub. Date: Nov. 21, 2019

(54) MODIFIED LIQUID CRYSTAL POLYMER, POLYMERIC FILM, AND METHOD FOR MANUFACTURING THE MODIFIED LIQUID CRYSTAL POLYMER

(71) Applicant: Zhen Ding Technology Co., Ltd., Taoyuan (TW)

(72) Inventors: SHOU-JUI HSIANG, Taoyuan (TW); NAN-KUN HUANG, Taoyuan (TW); YEN-JU CHENG, Taoyuan (TW)

(21) Appl. No.: 16/046,257

(22) Filed: Jul. 26, 2018

(30) Foreign Application Priority Data
May 16, 2018 (CN) 201810467225.6

(51) Int. Cl. C08G 63/60; C08G 63/81; C08J 5/18

(52) U.S. Cl. CPC C08G 63/605; C08J 2367/04; C08J 5/18; C08G 63/81

(57) ABSTRACT

A modified liquid crystal polymer has a chemical structural formula of

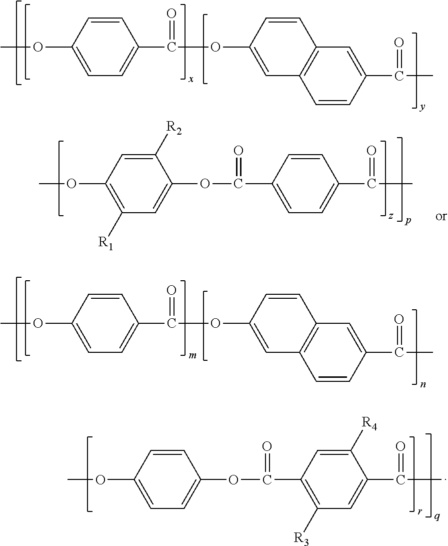

Wherein each of R₁, R₂, R₃, and R₄ is selected from at least one of chain alkyl group and chain alkoxy group. The chain alkoxy group is bonded to a phenyl group by an oxygen atom of the chain alkoxy group. A degree of polymerization p and a degree of polymerization q each is a natural number greater than 1. The modified liquid crystal polymer has a melting point of 220 degrees Celsius to 300 degrees Celsius. A polymeric film using the modified liquid crystal polymer and a method for manufacturing the modified liquid crystal polymer are also provided.

### FIELD

The subject matter herein generally relates to a modified liquid crystal polymer, a polymeric film using the modified liquid crystal polymer, and a method for manufacturing the modified liquid crystal polymer.

### BACKGROUND

Flexible circuit boards usually include insulating films. The insulating film need a low dielectric constant Dₖ and a low dielectric dissipation factor D_{f}. However, such insulating film has less-than-optimal film-forming properties.

Therefore, there is room for improvement within the art.

### BRIEF DESCRIPTION OF THE DRAWINGS

Implementations of the present technology will now be described, by way of example only, with reference to the attached figures.

FIG. 1 is a flowchart of an embodiment of a method for manufacturing a modified liquid crystal polymer.

FIG. 2 is a flowchart of an embodiment of a method for manufacturing a polymeric film using the modified liquid crystal polymer.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

An exemplary embodiment of a modified liquid crystal polymer has a chemical structural formula of

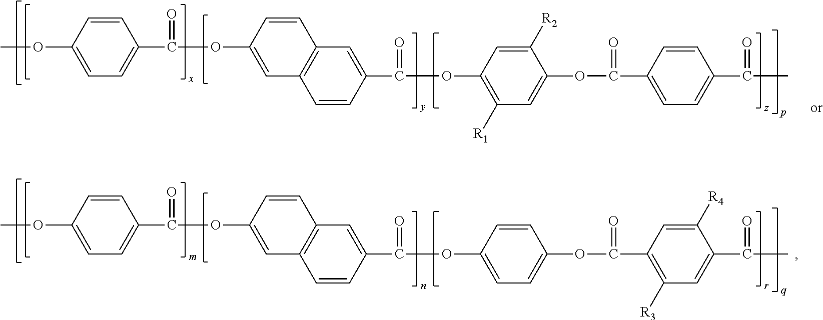

wherein each of R₁, R₂, R₃, and R₄ is selected from at least one of chain alkyl group and chain alkoxy group. The chain alkoxy group is bonded to a phenyl group by an oxygen atom of the chain alkoxy group. In at least one embodiment, each of R₁, R₂, R₃, and R₄ is selected from a group consisting of —C₄H₉, —OC₄H₉, —C₆H₁₃, —OC₆H₁₃, —C₈H₁₇, —OC₈H₁₇, and any combination thereof.

A degree of polymerization x, a degree of polymerization y and a degree of polymerization z are in a ratio of (45˜49):(45˜49):(2˜10). A degree of polymerization m, a degree of polymerization n, and a degree of polymerization r are in a ratio of (45˜49):(45˜49):(2˜10). In at least one embodiment, the ratio of the degree of polymerization x, the degree of polymerization y and the degree of polymerization z is selected from a group consisting of 49:49:2, 48:48:4, 47:47:6, 46:46:8, 45:45:10, and any combination thereof. The ratio of the degree of polymerization m, the degree of polymerization n, and the degree of polymerization r is selected from a group consisting of 49:49:2, 48:48:4, 47:47:6, 46:46:8, 45:45:10, and any combination thereof.

A degree of polymerization p and a degree of polymerization q is each a natural number greater than 1. The modified liquid crystal polymer has a melting point of about 220 degrees Celsius to about 300 degrees Celsius.

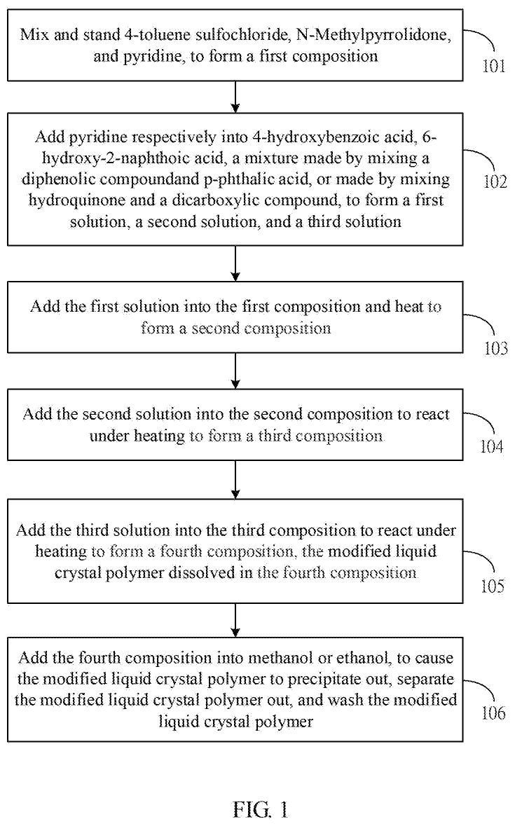

FIG. 1 illustrates a flowchart of a method for manufacturing a modified liquid crystal polymer in accordance with an exemplary embodiment. The exemplary method is provided by way of example, as there are a variety of ways to carry out the method. Each block shown in FIG. 1 represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 101.

At block 101, 4-toluene sulfochloride, N-Methylpyrrolidone (NMP), and pyridine are mixed and allowed to stand to form a first composition.

In at least one embodiment, a duration of the standing is greater than or equal to 30 min. A ration between 4-toluene sulfochloride, N-Methylpyrrolidone (NMP), and pyridine can be varied.

At block 102, pyridine is respectively added into 4-hydroxybenzoic acid, 6-hydroxy-2-naphthoic acid, a mixture made by mixing a diphenolic compound having a chemical structure formula of

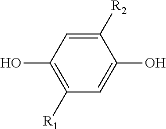

and p-phthalic acid, or made by mixing hydroquinone and a dicarboxylic compound having a chemical structure formula of

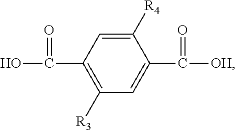

to cause 4-hydroxybenzoic acid to be dissolved and dispersed in the pyridine to form a first solution, 6-hydroxy-2-naphthoic acid to be dissolved and dispersed in the pyridine to form a second solution, and the mixture to be dissolved and dispersed in the pyridine to form a third solution. Each of R₁, R₂, R₃, and R₄ is selected from at least one of chain alkyl group and chain alkoxy group. The chain alkoxy group is bonded to a phenyl group by an oxygen atom of the chain alkoxy group. In at least one embodiment, each of R₁, R₂, R₃, and R₄ is selected from a group consisting of —C₄H₉, —OC₄H₉, —C₆H₁₃, —OC₆H₁₃, —C₈H₁₇, —OC₈H₁₇, and any combination thereof.

In the mixture, the diphenolic compound and p-phthalic acid are in a ratio of 1:1 by mass, or hydroquinone and the dicarboxylic compound are in a ratio of 1:1 by mass.

In at least one embodiment, 4-hydroxybenzoic acid, 6-hydroxy-2-naphthoic acid, the mixture are dissolved and dispersed in the pyridine by ultrasonic oscillation. In another embodiment, 4-hydroxybenzoic acid, 6-hydroxy-2-naphthoic acid, the mixture can be dissolved and dispersed in the pyridine by stirring.

At block 103, the first solution is added into the first composition and stirred for 10 min or more in nitrogen atmosphere at a temperature of about 60 degrees Celsius to about 100 degrees Celsius to form a second composition.

In at least one embodiment, 4-hydroxybenzoic acid and 4-toluene sulfochloride are in a ratio of 49:0.1 by mass.

At block 104, the second solution is added into the second composition to react for 30 min or more in nitrogen atmosphere at a temperature of about 60 degrees Celsius to about 100 degrees Celsius to form a third composition.

In at least one embodiment, 4-hydroxybenzoic acid and 6-hydroxy-2-naphthoic acid are in a ratio of 1:1 by mass.

At block 105, the third solution is added into the third composition to react for 24 hours or more in nitrogen atmosphere at a temperature of about 60 degrees Celsius to about 100 degrees Celsius to form a fourth composition. The modified liquid crystal polymer is dissolved in the fourth composition.

In at least one embodiment, 4-hydroxybenzoic acid and the mixture are in a ratio of about 45:10 to about 49:2 by mass. A duration of reacting is 24 hours.

At block 106, the fourth composition is added into methanol or ethanol, to cause the modified liquid crystal polymer to precipitate out. The modified liquid crystal polymer is separated out and washed.

In at least one embodiment, the modified liquid crystal polymer is separated out by air-extracting filtration and washed by methanol or ethanol to remove residual 4-toluene sulfochloride, NMP, and pyridine.

Wherein, a reaction mechanism to form the modified liquid crystal polymer of the method is as follows:

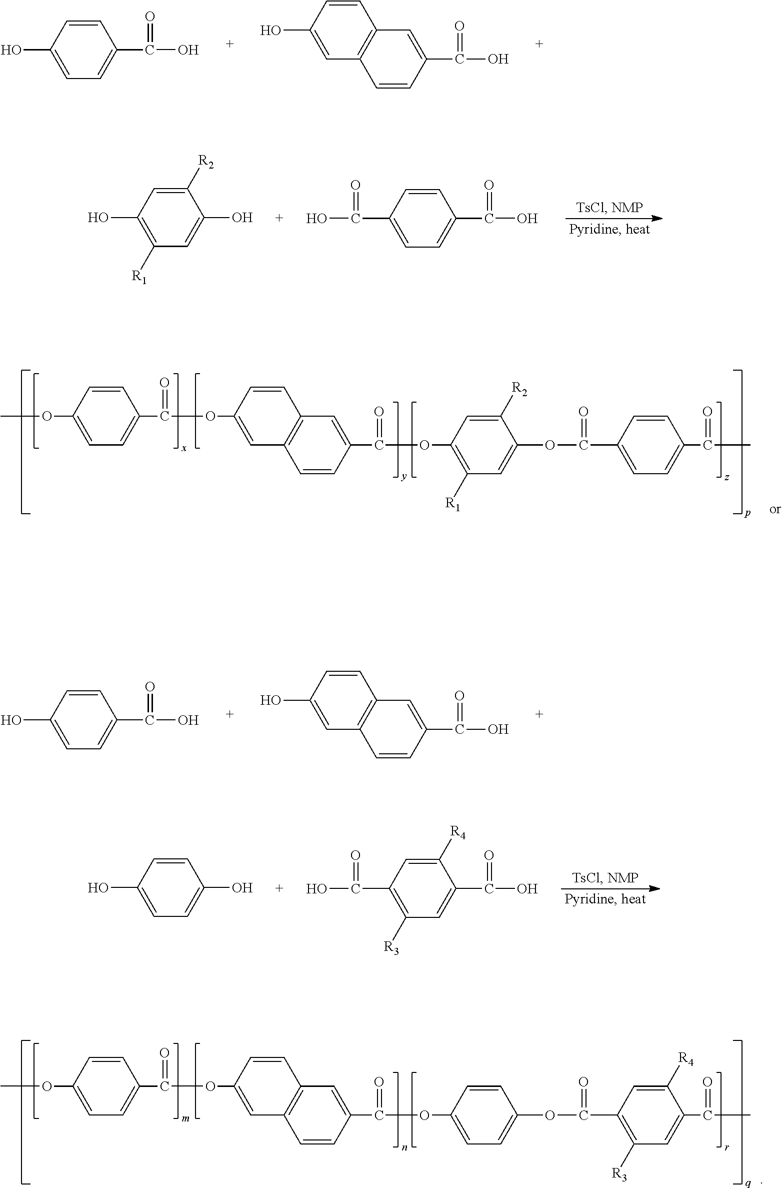

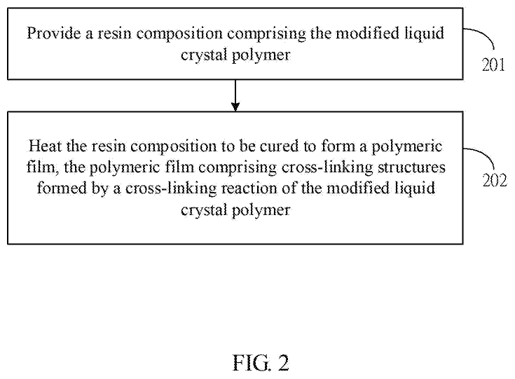

FIG. 2 illustrates a flowchart of a method for manufacturing a polymeric film using the modified liquid crystal polymer in accordance with an exemplary embodiment. The exemplary method is provided by way of example, as there are a variety of ways to carry out the method. Each block shown in FIG. 2 represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 201.

At block 201, a resin composition is provided. The resin composition comprises the modified liquid crystal polymer and a solvent. The modified liquid crystal polymer is dissolved in the solvent. In at least one embodiment, the resin composition has a viscosity of about 1000 cps to about 2000 cps.

In at least one embodiment, the solvent can be NMP. In another embodiment, the solvent can be varied as needed.

At block 202, the resin composition is heated to be cured to form the polymeric film. The polymeric film comprises cross-linking structures formed by a cross-linking reaction of the modified liquid crystal polymer.

In at least one embodiment, the resin composition is heated for about 20 min to about 40 min at a temperature of about 130 degrees Celsius to about 150 degrees Celsius.

The modified liquid crystal polymer comprises chemical structures

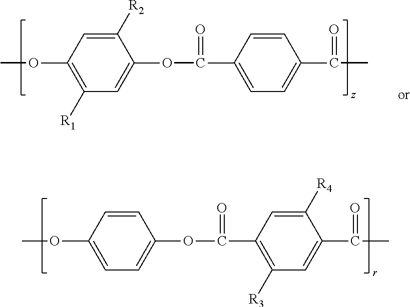

comprising long chain structures selected from at least one of chain alkyl group and chain alkoxy group as side chains. So that the modified liquid crystal polymer has a low melting point to improve its solubility in the solvent. As a result, the polymeric film made by the modified liquid crystal polymer has excellent film-forming properties.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

### Example 1

0.1 g of 4-toluene sulfochloride, 50 mL of NMP, and 3 mL of pyridine were mixed and standing for 30 min to form a first composition.

0.2 g of pyridine was respectively added into 0.49 mol of 4-hydroxybenzoic acid, 0.49 mol of 6-hydroxy-2-naphthoic acid, and a mixture made by 0.02 mol of 2,5-din-butylhydroquinone and 0.02 mol of p-phthalic acid, to cause 4-hydroxybenzoic acid, 6-hydroxy-2-naphthoic acid, and the mixture to be dissolved in pyridine, thereby forming a first solution, a second solution, and a third solution in that sequence.

The first solution was added into the first composition and stirred for 10 min in nitrogen atmosphere at a temperature of 80 degrees Celsius to form a second composition.

The second solution was added into the second composition to react for 30 min in nitrogen atmosphere at a temperature of 80 degrees Celsius to form a third composition.

The third solution was added into the third composition to react for 24 hours in nitrogen atmosphere at a temperature of 80 degrees Celsius to form a fourth composition containing a modified liquid crystal polymer.

The fourth composition was added into methanol or ethanol to precipitate out the modified liquid crystal polymer, and then the modified liquid crystal polymer was separated out by air-extracting filtration and washed by methanol.

The modified liquid crystal polymer was dissolved in NMP to form a resin composition. The resin composition had a viscosity of 1254 cps, and a solid content of 25 wt. %.

### Example 2

Different from the example 1, 4-hydroxybenzoic acid was 0.48 mol, 6-hydroxy-2-naphthoic acid was 0.48 mol, 2,5-din-butylhydroquinone was 0.04 mol, and p-phthalic acid was 0.04 mol. The resin composition had a viscosity of 1421 cps, and a solid content of 25 wt. %.

### Example 3

Different from the example 1, 4-hydroxybenzoic acid was 0.47 mol, 6-hydroxy-2-naphthoic acid was 0.47 mol, 2,5-din-butylhydroquinone was 0.06 mol, and p-phthalic acid was 0.06 mol. The resin composition had a viscosity of 1542 cps, and a solid content of 25 wt. %.

### Example 4

Different from the example 1, 4-hydroxybenzoic acid was 0.46 mol, 6-hydroxy-2-naphthoic acid was 0.46 mol, 2,5-din-butylhydroquinone was 0.08 mol, and p-phthalic acid was 0.08 mol. The resin composition had a viscosity of 1624 cps, and a solid content of 25 wt. %.

### Example 5

Different from the example 1, 4-hydroxybenzoic acid was 0.45 mol, 6-hydroxy-2-naphthoic acid was 0.45 mol, 2,5-din-butylhydroquinone was 0.1 mol, and p-phthalic acid was 0.1 mol. The resin composition had a viscosity of 1742 cps, and a solid content of 25 wt. %.

### Example 6

Different from the example 1, 0.02 mol of 2,5-din-butylhydroquinone and 0.02 mol of p-phthalic acid were replaced by 0.02 mol of hydroquinone and 0.02 mol of 2,5-din-butyl-p-phthalic acid

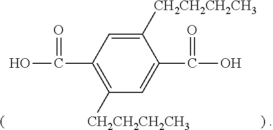

The resin composition had a viscosity of 1389 cps, and a solid content of 25 wt. %.

### Example 7

Different from the example 2, 0.04 mol of 2,5-din-butylhydroquinone and 0.04 mol of p-phthalic acid were replaced by 0.04 mol of hydroquinone and 0.04 mol of 2,5-din-butyl-p-phthalic acid

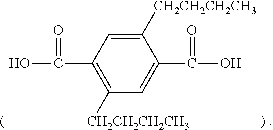

The resin composition had a viscosity of 1341 cps, and a solid content of 25 wt. %.

### Example 8

Different from the example 3, 0.06 mol of 2,5-din-butylhydroquinone and 0.06 mol of p-phthalic acid were replaced by 0.06 mol of hydroquinone and 0.06 mol of 2,5-din-butyl-p-phthalic acid

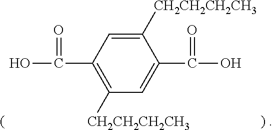

The resin composition had a viscosity of 1442 cps, and a solid content of 25 wt. %.

### Example 9

Different from the example 4, 0.08 mol of 2,5-din-butylhydroquinone and 0.08 mol of p-phthalic acid were replaced by 0.08 mol of hydroquinone and 0.08 mol of 2,5-din-butyl-p-phthalic acid

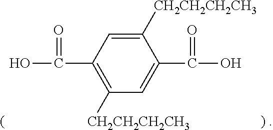

The resin composition had a viscosity of 1751 cps, and a solid content of 25 wt. %.

### Example 10

Different from the example 5, 0.1 mol of 2,5-din-butylhydroquinone and 0.1 mol of p-phthalic acid were replaced by 0.1 mol of hydroquinone and 0.1 mol of 2,5-din-butyl-p-phthalic acid

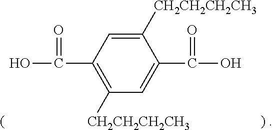

The resin composition had a viscosity of 1841 cps, and a solid content of 25 wt. %.

Ten first test samples were made. Each of the ten first test samples comprises a copper foil and a polymeric film made by the resin compositions of the examples 1, 2, 3, 4, 5, 6, 7, 8, 9, and 10, respectively, through heating for 30 min at 140 degrees Celsius. The polymeric films of the ten first test samples have the same thickness. A liquid crystal polymeric film (Manufacturer: Polyplastica Co. Ltd., Model: VECTRA V400P) as a comparative example was pressed on a copper foil at about 300 degrees Celsius to about 350 degrees Celsius to form a second test samples.

Dielectric constant Dₖ, and dielectric dissipation factor D_{f} of each of the polymeric films formed by the resin compositions of examples 1 to 10 and the liquid crystal polymeric film were tested. Thermal resistance of the ten first test samples and the second test samples were tested. Solubility of the modified liquid crystal polymers of examples 1 to 10 and a liquid crystal polymer corresponding to the liquid crystal polymeric film in NMP were tested. Melting point of the modified liquid crystal polymers of examples 1 to 10 and a liquid crystal polymer corresponding to the liquid crystal polymeric film were tested. Test results were shown in the following Table 1. The thermal resistance was tested at a temperature of 320 degrees centigrade for 10 seconds, if the polymeric film or the liquid crystal polymeric film did not blister and peel off, the result of the thermal resistance test is considered passing, otherwise, the result fails.

TABLE 1

| | Product | | | | | | | | | | |
|---|---|---|---|---|---|---|---|---|---|---|---|
| | Example | Example | Example | Example | Example | Example | Example | Example | Example | Example | Comparative |
| Property | 1 | 2 | 3 | 4 | 5 | 6 | 7 | 8 | 9 | 10 | example |
| Dₖ (10 GHz) | 2.92 | 2.96 | 3.11 | 3.11 | 3.14 | 2.93 | 2.96 | 2.98 | 3.1 | 3.1 | 2.96 |
| D_{f} (*10⁻³, | 2 | 2 | 3 | 3 | 3 | 2 | 2 | 3 | 3 | 4 | 2 |
| 10 GHz) | | | | | | | | | | | |
| Results of the | Pass | Pass | Pass | Pass | Pass | Pass | Pass | Pass | Pass | Pass | Pass |
| thermal | | | | | | | | | | | |
| resistance test | | | | | | | | | | | |
| Solubility | Soluble | Soluble | Soluble | Soluble | Soluble | Soluble | Soluble | Soluble | Soluble | Soluble | Insoluble |
| Melting point | 276 | 270 | 264 | 254 | 248 | 281 | 274 | 271 | 268 | 257 | 330 |
| (° C.) | | | | | | | | | | | |

According to the Table 1, the dielectric constant factor of the polymeric films formed by the resin compositions of examples 1 to 10 each is lower than 3.2. The polymeric films made by the resin compositions of the examples 1 to 10 have a preferred thermal resistance, respectively. In addition, the modified liquid crystal polymers of examples 1 to 10 can be soluble in NMP. As a result, the modified liquid crystal polymer has excellent film-forming properties.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

1. A modified liquid crystal polymer having a chemical structural formula of 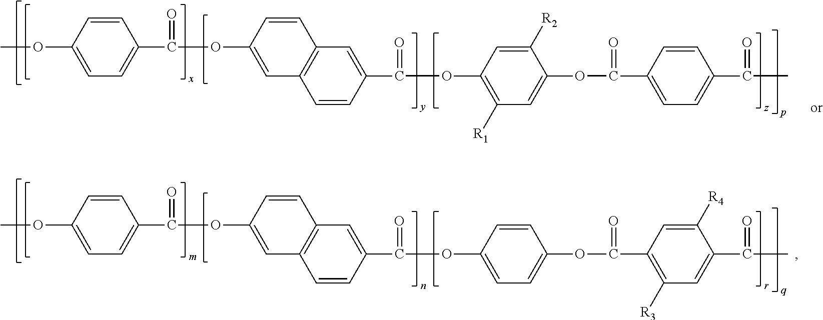
wherein each of R₁, R₂, R₃, and R₄ is selected from at least one of chain alkyl group and chain alkoxy group, the chain alkoxy group is bonded to a phenyl group by an oxygen atom of the chain alkoxy group, a degree of polymerization p and a degree of polymerization q each is a natural number greater than 1, and the modified liquid crystal polymer has a melting point of 220 degrees Celsius to 300 degrees Celsius.

2. The modified liquid crystal polymer of claim 1, wherein each of R₁, R₂, R₃, and R₄ is selected from a group consisting of —C₄H₉, —OC₄H₉, —CO₆H₁₃, —C₈H₁₇, —OC₈H₁₇, and any combination thereof.

3. The modified liquid crystal polymer of claim 1, wherein a degree of polymerization x, a degree of polymerization y and a degree of polymerization z are in a ratio of (45˜49):(45˜49):(2˜10), or a degree of polymerization m, a degree of polymerization n, and a degree of polymerization r are in a ratio of (45˜49):(45˜49):(2˜10).

4. A method for manufacturing a modified liquid crystal polymer:
mixing and standing 4-toluene sulfochloride, N-Methylpyrrolidone, and pyridine, to form a first composition;
adding pyridine respectively into 4-hydroxybenzoic acid, 6-hydroxy-2-naphthoic acid, a mixture made by mixing a diphenolic compound having a chemical structure formula of 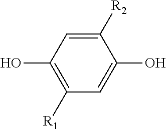
and p-phthalic acid, or made by mixing hydroquinone and a dicarboxylic compound having a chemical structure formula of 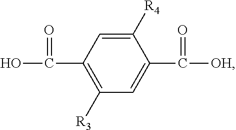
to cause 4-hydroxybenzoic acid to be dissolved in the pyridine to form a first solution, 6-hydroxy-2-naphthoic acid to be dissolved in the pyridine to form a second solution, and the mixture to be dissolved in the pyridine to form a third solution; wherein each of R₁, R₂, R₃, and R₄ is selected from at least one of chain alkyl group and chain alkoxy group, and the chain alkoxy group is bonded to a phenyl group by an oxygen atom of the chain alkoxy group;
adding the first solution into the first composition and heating to form a second composition;
adding the second solution into the second composition to react under heating to form a third composition;
adding the third solution into the third composition to react under heating to form a fourth composition, the modified liquid crystal polymer having a chemical structural formula of 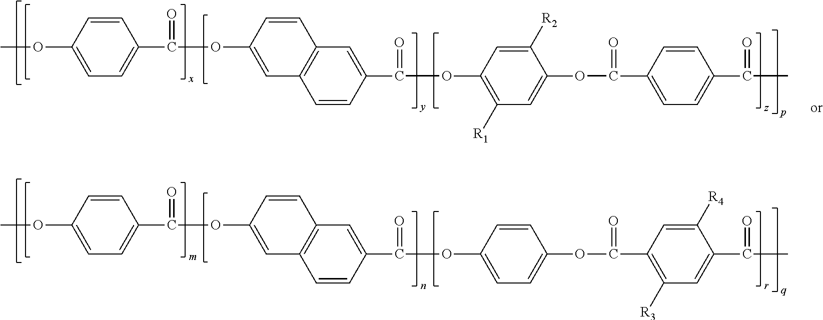
dissolved in the fourth composition, wherein a degree of polymerization p and a degree of polymerization q each is a natural number greater than 1; and
adding the fourth composition into methanol or ethanol, to cause the modified liquid crystal polymer to precipitate out, and separating the modified liquid crystal polymer out and washing, the modified liquid crystal polymer having a melting point of 220 degrees Celsius to 300 degrees Celsius.

5. The method of claim 4, wherein each of R₁, R₂, R₃, and R₄ is selected from a group consisting of —C₄H₉, —OC₄H₉, —C₆H₁₃, —OC₆H₁₃, —OC₈H₁₇, and any combination thereof.

6. The method of claim 4, wherein the diphenolic compound and p-phthalic acid are in a ratio of 1:1 by mass, or hydroquinone and the dicarboxylic compound are in a ratio of 1:1 by mass.

7. The method of claim 4, wherein 4-hydroxybenzoic acid and 4-toluene sulfochloride are in a ratio of 49:0.1 by mass.

8. The method of claim 4, wherein 4-hydroxybenzoic acid and 6-hydroxy-2-naphthoic acid are in a ratio of 1:1 by mass.

9. The method of claim 4, wherein 4-hydroxybenzoic acid and the mixture are in a ratio of 45:10 to 49:2 by mass.

10. The method of claim 4, wherein a degree of polymerization x, a degree of polymerization y and a degree of polymerization z are in a ratio of (45˜49):(45˜49):(2˜10), or a degree of polymerization m, a degree of polymerization n, and a degree of polymerization r are in a ratio of (45˜49):(45˜49):(2˜10).

11. A polymeric film formed by heating a resin composition comprising a modified liquid crystal polymer, wherein the modified liquid crystal polymer has a chemical structural formula of 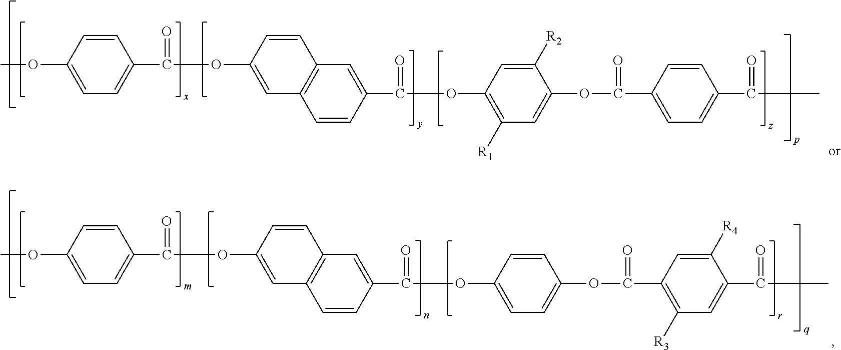
each of R₁, R₂, R₃, and R₄ is selected from at least one of chain alkyl group and chain alkoxy group, the chain alkoxy group is bonded to a phenyl group by an oxygen atom of the chain alkoxy group, a degree of polymerization p and a degree of polymerization q each is a natural number greater than 1, and the modified liquid crystal polymer has a melting point of 220 degrees Celsius to 300 degrees Celsius, the polymeric film comprises cross-linking structures formed by a cross-linking reaction of the modified liquid crystal polymer.

12. The polymeric film of claim 11, wherein each of R₁, R₂, R₃, and R₄ is selected from a group consisting of —C₄H₉, —OC₄H₉, —C₆H₁₃, —OC₆H₁₃, —C₈H₁₇, —OC₈H₁₇, and any combination thereof.

13. The polymeric film of claim 11, wherein a degree of polymerization x, a degree of polymerization y and a degree of polymerization z are in a ratio of (45˜49):(45˜49):(2˜10), or a degree of polymerization m, a degree of polymerization n, and a degree of polymerization r are in a ratio of (45˜49):(45˜49):(2˜10).
